(19) United States
(12) Patent Application Publication
(10) Pub. No.: US 2009/0039135 A1
(43) Pub. Date: Feb. 12, 2009

(54) ATTACHING AND DETACHING METHOD OF CONTACT TOP OF NAILING MACHINE

(75) Inventor: Kouji Kubo, Tokyo (JP)

Correspondence Address: DRINKER BIDDLE & REATH (DC), 1500 K STREET, N.W., SUITE 1100, WASHINGTON, DC, 20005-1209, US

(73) Assignee: MAX CO., LTD., Tokyo (JP)

(21) Appl. No.: 12/282,748

(22) PCT Filed: Mar. 13, 2007
(86) PCT No.: PCT/JP2007/054990

§ 371 Date: Sep. 14, 2008

(30) Foreign Application Priority Data
Mar. 14, 2006 (JP) 2006-069679

(51) Int. Cl. B27F 7/00

(52) U.S. Cl. 227/120

(57) ABSTRACT

A contact top 8 is arranged at a lower end of a wear plate 6 provided on a lower side of a tool main body 1. The contact top 8 is attached to and detached from a front end of a contact arm 12 provided at a vicinity of an injection port. An engaging groove 26 is formed at a side portion of the contact top 8. The contact top 8 is made to be movable such that the engaging groove 26 comes out from and goes into a lower end of a side portion of a driver guide 5. A front end portion 17 of the contact arm 12 is made to be able to be brought into contact with and separate from the contact top 8. In a state of maximally moving the front end portion 17 to the lower side, the contact arm 12 is capable of being attached to and detached from the engaging groove 26 of the contact top 8 exposed from a lower end between a wear plate 6 and the driver guide 5.

### TECHNICAL FIELD

The present invention relates to an attaching and detaching method of attaching or detaching a contact top to and from a front end of a contact arm of a nailing machine of a nail or the like.

### BACKGROUND ART

A nailing machine strikes of a nail of a nail, a screw or the like to a work to be nailed and includes a contact arm as a safety apparatus. There is known a contact arm constituted such that one end thereof is projected from a front end of an injection port of a striking tool, other end thereof is arranged to be engaged with a starting trigger, and the nailing machine is operated only when the one end of the contact arm is pressed to the work to be nailed when the trigger is pulled. Further, the nailing machine is constituted such that, the contact arm is urged by a spring to project from a front end of a nose portion in a striking direction, by pressing a front end portion of the contact arm to the work to be nailed until the front end of the nose portion is butted to a portion to be nailed, the front end portion is relatively moved to an opposite side of a pressing direction, it is detected by the movement that the front end of the nose portion is butted to the work to be nailed, and finally an operation of the trigger is made to be effective.

That is, by pressing the contact arm to the work to be nailed, the contact arm is pressed, thereby, an operation of starting the trigger valve for starting the striking tool is made to be effective.

The front end of the contact arm is urged by the spring to project from the front end of the nose portion in the striking direction, when the contact arm is pressed to the work to be nailed, the contact arm is made to be pressed thereto. However, when the work to be nailed is a decorative member having a comparative soft material, there is a case in which a defect or a press mark is produced at a surface thereof. In order to prevent the drawback, the front end of the contact arm is attached with a contact top (front end member) made of a synthetic resin, thereafter, operated to press thereto.

However, since there are a case of using the contact top and a case of not using the contact top, it is necessary that attachment and detachment thereof is facilitated, and attachment and detachment can be carried out without using a tool of a spanner or the like. Further, in the background art, there is known a contact top (nose cap) facilitating attachment and detachment, for example, there is known a contact top comprising an elastic member which can simply be attached by engaging a projected portion of the contact top with a recessed portion of a contact arm by simply fitting the contact top to a front end of the contact arm (push lever) (refer to, for example, JP-A-2005-007544).

Further, the applicant of the present invention has proposed a contact top of a nailing tool made to be adaptable to striking connected nails (pin nail) at a narrow space. According to the contact top, a front end thereof is curved by a curved portion comprising an elastic member, loosely fitted to a nose portion having an injection path of a nail formed by overlapping a wear plate and a driver guide slidably in an up and down direction and attached attachably and detachably to and from a front end of a contact arm (refer to, for example, JP-A-2005-168524).

Meanwhile, whereas according to the contact arm (nose cap) capable of being attached and detached by being simply fitted to the front end of the contact arm, attachment and detachment thereof is facilitated, the contact arm is easy to be detached, and therefore, the contact arm is easy to lost, further, when the contact top is detached in an operation of striking a nail, a continuity of the operation of striking the nail is stopped, and therefore, an operational performance thereof is deteriorated, at the same time, when work to be nailed is a decorative member having a comparatively soft material, there is a concern of producing a defect or a press mark at a surface of the decorative member.

Further, according to the technology of attaching and detaching the contact top to and from the front end of the contact arm, the contact top is arranged on an inner side of the driver guide, and therefore, when the contact top is attached or detached for replacing the contact top or the like, first, the driver guide is detached by loosening a bolt, further, an engagement of the contact arm and the contact top is disengaged and the arm is rotated and the contact top is detached from a guide of the wear plate of the nose portion by sliding the contact top to draw to a lower side.

In these ways, it is necessary to detach the driver guide for replacing the contact top, and therefore, the contact top needs to be replaced by using a tool of a spanner or the like, the replacing operation is troublesome, a time period is required for replacing the contact top and the operational performance is not excellent and a problem remains in this respect.

### DISCLOSURE OF THE INVENTION

One or more of embodiments of the invention provide a method of attaching and detaching a contact top in a striking tool in which the contact top can be easily and firmly attached and detached without using a tool of a spanner or the like such that the contact top is not detached in an operation of striking a nail.

According to one or more of embodiments, in a first aspect, in a method of attaching and detaching a contact top of a nailing machine in which an injection port of a nail between a wear plate is provided on a lower side of a tool main body and a driver guide arranged on the wear plate, a contact top is arranged at a lower end of the wear plate slidably along a direction of striking the nail, a contact arm is provided movably in parallel with the direction of striking the nail, and the contact top is attached to and detached from a front end of the contact arm, an engaging groove is formed at a side portion of the contact top, the contact top is movable such that the engaging groove comes out from and goes into an inner side of the driver guide, a front end portion of the contact arm is provided to be able to be brought into contact with and separate from the contact top, and the contact arm is capable of being attached to and detached from the engaging groove of the contact top exposed from the inner side of the driver guide in a state of maximally moving the front end portion of the contact arm to the lower side.

According to a second aspect, there may be constructed a constitution in which an amount of moving the contact arm is constituted by adding a moving amount thereof until the contact top is completely exposed from the driver guide further to a moving amount in a normal use.

According to the first aspect, whereas the contact top is made to be movable such that the engaging groove of the side portion comes out from and goes into the inner side of the driver guide, the front end portion of the contact arm is provided to be able to be brought into contact with and separate from the contact top, in a state of maximally moving the front end portion of the contact arm to the lower side, when the top is exposed from the inner side of the driver guide, the front end portion of the contact arm is attached to or detached from the engaging groove of the contact top. Therefore, according to the attaching and detaching method, in attaching and detaching the contact top, it is not necessary to disengage the driver guide, and therefore, also a tool is not needed, and therefore, the contact top is attached and detached very easily.

Further, the contact top is attached to the contact arm, and therefore, the contact top is not detached in operation.

According to the second aspect, the amount of moving the contact arm is constituted by adding the moving amount until the contact top is completely exposed from the driver guide further to the moving amount in the normal use, and therefore, the contact top is not exposed in the normal operation. Therefore, the contact top is not detached from the front end of the contact arm in the operation.

Other aspects and advantages of the invention will be apparent from the following description, the drawings and the claims.

### BRIEF DESCRIPTION OF THE DRAWINGS:

FIG. 1 is a side view of a nailing machine according to the invention.

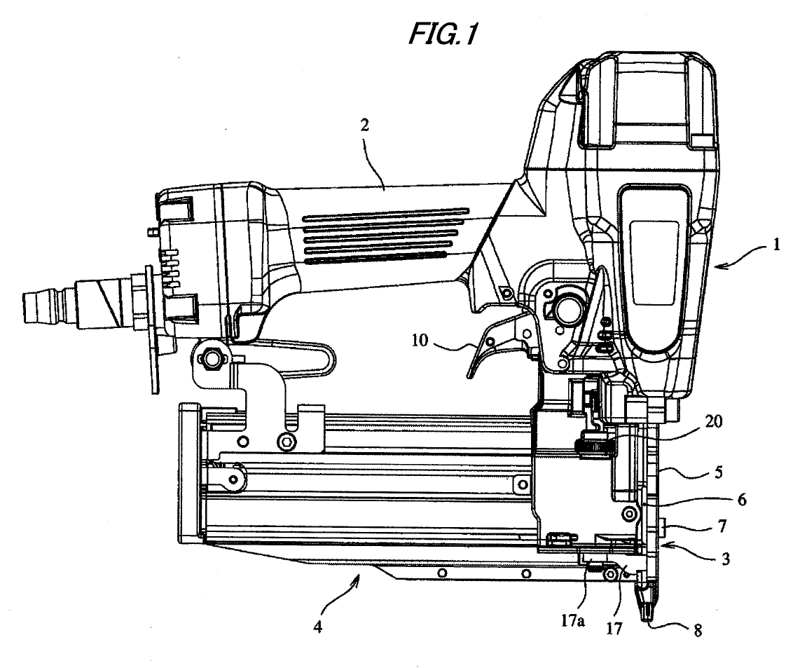

FIG. 2 is a disassembled perspective view of a nose portion and a contact top omitting a driver guide of the nailing machine.

FIG. 3 is a side view partially sectionally showing essential portions of the nose portion and the contact arm and a peripheral portion of the nailing machine.

FIG. 4 is a side view of the essential portions in a state of moving the contact arm by pulling a trigger.

FIG. 5 is a side view in a state of moving to adjust the contact arm further to a lower side by adjustment by an adjust dial.

FIG. 6 is a side view showing a state of pulling down a lower end of the contact arm further to a lower side.

FIG. 7 is a perspective view showing a state of pivoting a pivot arm.

### DESCRIPTION OF REFERENCE NUMERALS AND SIGNS

3 nose portion
4 magazine
5 driver guide
6 wear plate
8 contact top
10 trigger
11 trigger valve for starting
12 contact arm
17 pivoting arm
26 engaging groove

### BEST MODE FOR CARRYING OUT THE INVENTION

An exemplary embodiment of the invention will be explained in reference to the drawings as follows.

In the drawings, notations designate a nailing machine. The nailing machine includes a tool main body 1 including a strike mechanism, a grip 2 arranged on a rear side of the tool main body 1 and a nose portion 3 provided at a lower portion of the tool main body 1, and a straight shape magazine 4 in a rectangular shape for supplying connecting nails (pin nails) to the nose portion 3 for striking a front nail supplied from a nail supply path 9 at inside of the magazine 4 to the nose portion 3 by a driver integrally coupled with a driving piston constituting the strike mechanism (not illustrated).

### <Nose Portion>

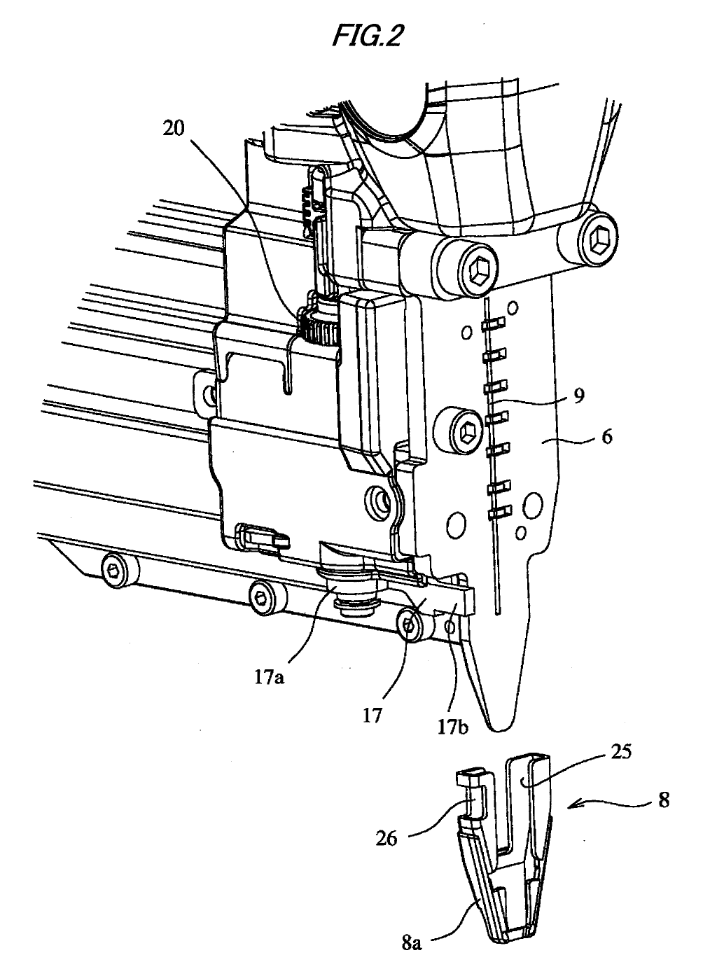

The nose portion is constituted by a driver guide 5 constituting a front wall and a wear plate 6 (refer to FIG. 2) constituting a rear wall, the driver guide 5 is made to be attachable and detachable to and from the wear plate 6 by a bolt 7 and when integrally coupled, a path of injecting a nail is formed therebetween. A lower end of the wear plate 6 is arranged with a contact top 8.

### <Contact Arm>

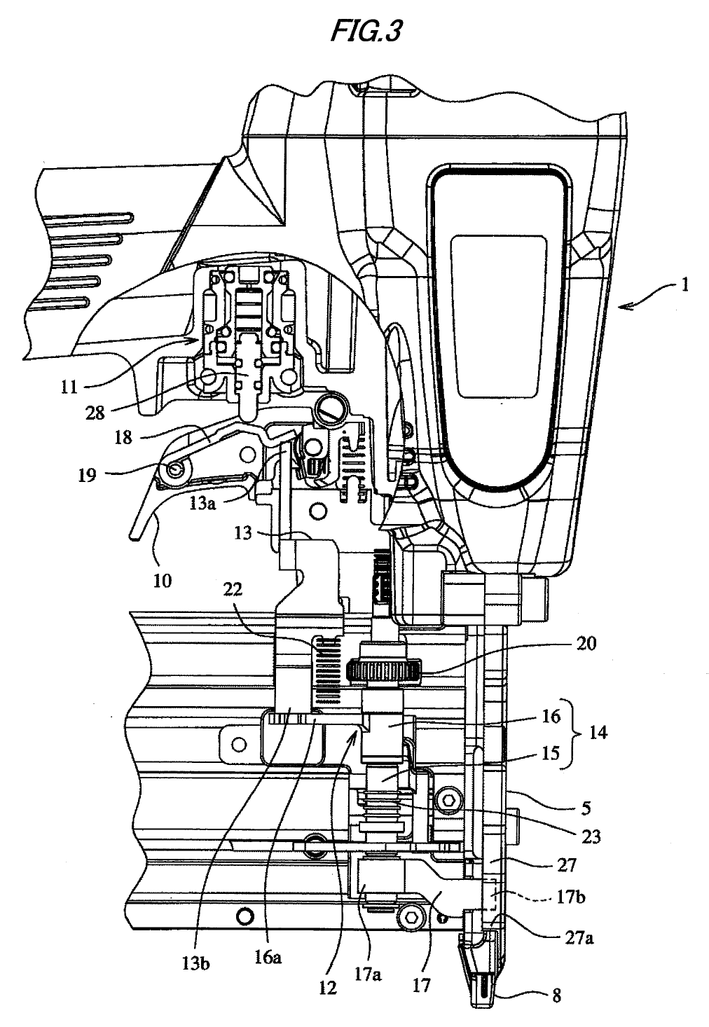

In striking out a nail, by operating a trigger valve 11 for starting shown in FIG. 3 by pulling a trigger 10, compressed air supplied from an air compressor is sent to the strike mechanism and the front nail is struck out by an air pressure thereof, an operation of pulling the trigger 10 is interlocked with an operation of a contact arm 12, and is constituted to be able to operate the trigger valve 11 effectively when actually pressed to work to be nailed.

That is, the contact arm 12 is constituted by an upper arm 13 and a middle adjusting member 14 and a pivoting arm 17 at a lower portion. An upper end 13a of the upper arm 13 is arranged to be able to engage with a front end portion of a contact lever 18 of the trigger 10. The contact lever 18 is made to be able to be pivoted centering on a support shaft 19. The adjusting member 14 is fitted with a hollow portion 16 having a horizontal arm 16a at a middle of an adjust bolt 15 having a screw portion (not illustrated) at a lower end thereof, the hollow portion 16 is constituted to move rotatably relative to the adjust bolt 15 and integrally therewith in an up and down direction. An end portion of the horizontal arm 16a is arranged to be able to engage with a lower end 13b of the upper arm 13. The screw portion at the lower end of the adjust bolt is screwed with a female screw portion formed at inside of a cylinder portion 17a at one end of the pivoting arm 17. Further, an upper portion of the adjust bolt 15 is provided with an adjust dial 20. The adjust dial 20 is held at a constant position of the tool main body 1, a center thereof is penetrated to be formed with a bearing hole in a noncircular shape of a D-like shape or the like in a section thereof and the baring hole is fitted with an upper portion of the adjust bolt 15. Therefore, although by turning the adjust dial 20, also the adjust bolt 15 is rotated integrally therewith, the both are constituted movably relative to each other in the up and down direction. Therefore, by turning the adjust dial 20, also the adjust bolt 15 is rotated, and therefore, the pivoting arm 17 is screwed to progress, and therefore, a position thereof can be adjusted in the up and down direction. Further, the upper arm 13 is urged to an upper side by a spring 22 and the adjust bolt 15 and the pivoting arm 17 are urged to the upper side by a spring 23, respectively.

### <Amount of Moving Contact Arm>

A front end portion of the pivoting arm 17 is held to an inner side of a side portion of the driver guide 5, thereby, pivoting of the pivoting arm 17 to an outer side is restricted.

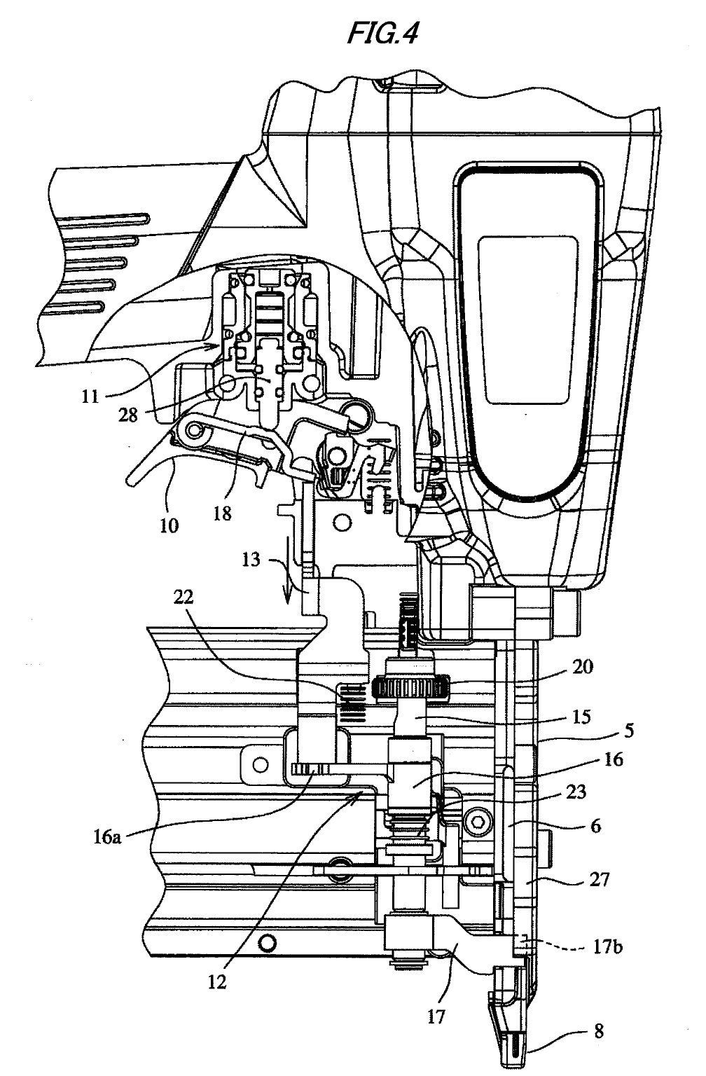

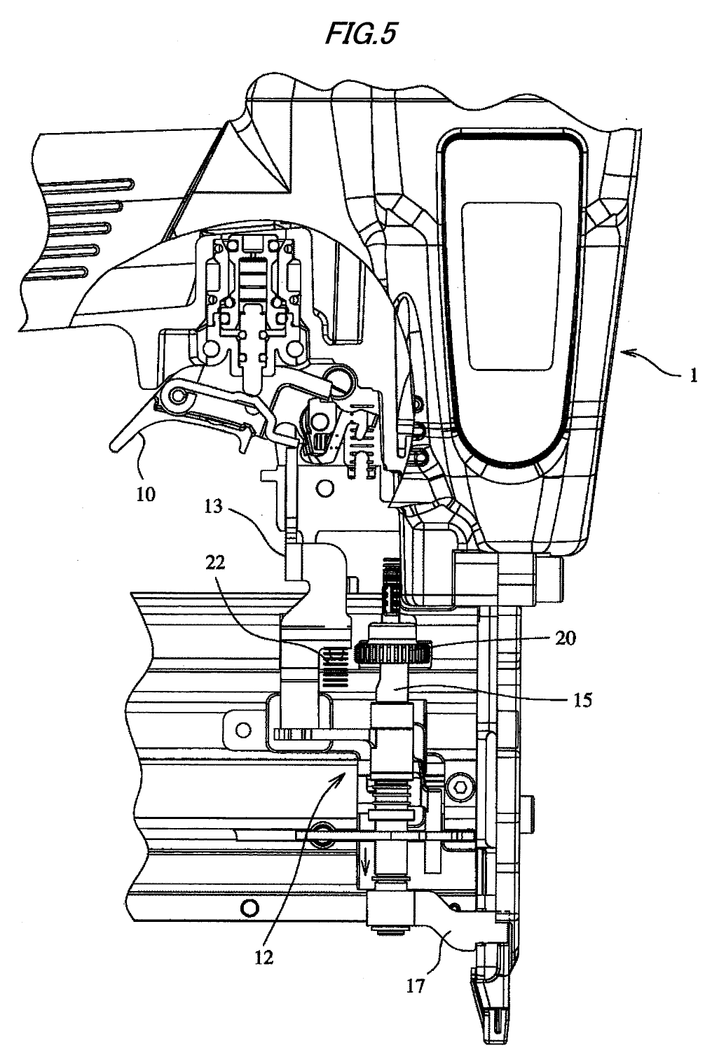

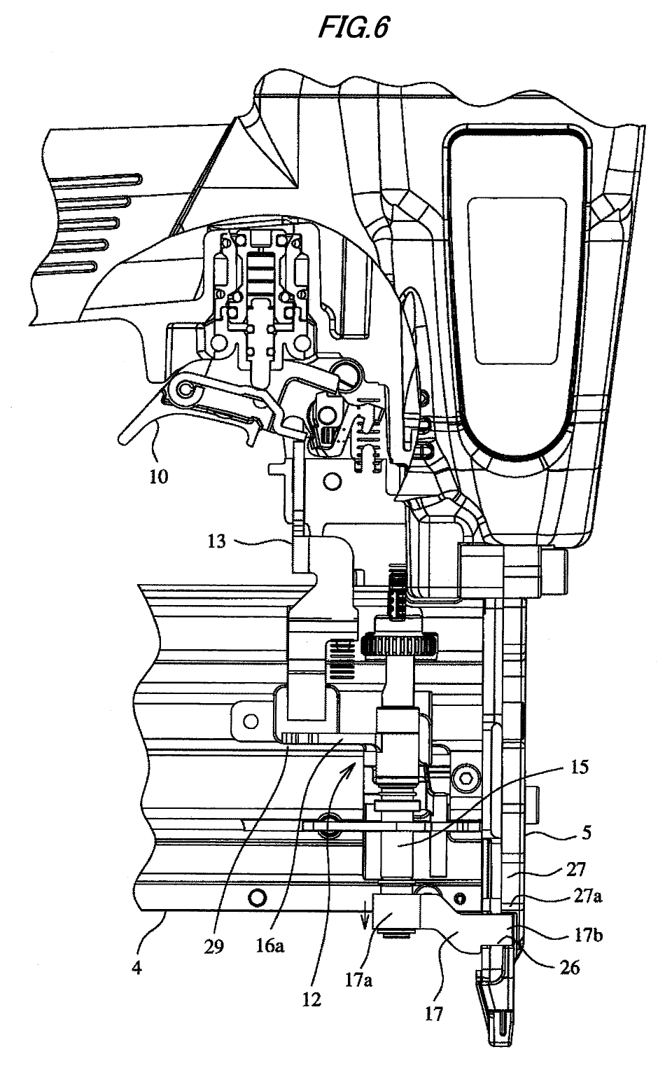

An amount of moving the pivoting arm 17 of the contact arm 12 to the lower side is a moving amount moving in accordance with moving the upper arm 13 to a lowermost end (position of FIG. 4), and a moving amount of moving further to a lower side of by the dial 20 (position of FIG. 5) is a moving amount in normal use, further, the pivoting arm 17 can be moved additionally by pulling the pivoting arm 17 to the lower side. The additional movement for a region of the normal use is set to a moving amount until the front end portion of the contact arm 12 is completely exposed from the driver guide 5 (position of FIG. 6).

In this way, the region of normal use is from the position of FIG. 3 to the positions of FIG. 4 and FIG. 5, further can be moved to the position of FIG. 6, the moving amount to the additional position is a maximum moving amount of the contact arm 12.

### <Contact Top>

Next, as shown by FIG. 2, the contact top 8 is formed to be thin-walled from a metal of iron, stainless steel or the like by a member having an outer shape in correspondence with a shape of a lower portion of the wear plate 6 substantially the same therewith and larger than the shape of the lower portion of the wear plate 6 by one size, and an outer side face of a front end thereof is fixed with an elastic member 8a of a synthetic resin or the like. Both side portions of the contact top 8 are formed with a guide groove 25 engaged with both side edges of the wear plate 6. Further, both side portions of a lower portion of the wear plate 6 are engaged with inner sides of the guide groove 25, and the contact top 8 is made to be able to slide along the wear plate 6 while maintaining the engaging state.

An engaging groove 26 is formed at one side of an upper portion of the contact top 8 to open in a side direction (outer direction).

The pivoting arm 17 at the front end portion of the contact arm 12 is provided to be able to be brought into contact with and separate from the contact top 8 by being pivoted centering on the adjust bolt 15, and the pivoting arm 17 is attached with the contact top 8.

A side portion of the driver guide 5 is formed with a cover portion 27 for closing the engaging groove 26 of the contact top 8 and holding the front end portion of the pivoting arm 17 of the contact arm 12. Further, the contact top 8 is made to be movable between the wear plate 6 and the driver guide 5, that is, to a degree by which the engaging groove 26 comes out from and goes into a lower end 27a (refer to FIG. 3) of the cover portion 27.

### <Operation of Nailing Machine>

In the above-described constitution, in operating the nailing machine, when the trigger 10 is pulled, as shown by FIG. 4, an upper face of the contact lever 18 provided at the trigger 10 is butted to a valve stem 28 of the trigger valve 11, and therefore, a front end thereof presses down the upper arm 13 of the contact arm 12 to the lower side against the springs 22 and 23, and therefore, in accordance therewith, the upper arm 13 moves the adjust bolt 15 to the lower side along with the horizontal arm 16a. At the same time, also the contact top 8 is moved to be projected to the lower side along with the pivoting arm 17. In this way, when a struck member or the like is not present at the front end of the contact top 8 and the contact arm 12 is moved to the lower side by a full stroke, also the trigger is idly operated and even when the trigger 10 is pulled to a topmost end, the valve stem 28 of the trigger valve 11 cannot be pressed.

In contrast thereto, when the front end of the contact arm 12 is butted to work to be nailed, the contact arm 12 cannot be moved to the lower side. Therefore, when the trigger 10 is pulled, the front end of the contact lever 18 is not moved down, and therefore, the upper face of the contact lever 18 presses the trigger valve stem 28, the trigger valve 11 is operated and the nailing machine is started.

Further, by pivoting the adjust dial 20 from a state of FIG. 4, as shown by FIG. 5, the contact arm 12 can be moved down further. That is, the contact arm 12 can be adjusted by an amount of projecting the contact arm 12 from a lower end of the tool main body 1.

### <Attachment and Detachment of Contact Top>

Next, an operation of attaching and detaching the contact top 8 will be explained.

As shown by FIG. 5, when the adjust bolt 15 is maximally moved down by an adjust mount by rotating the adjust dial 20, also the pivoting arm 17 and the contact top 8 are further moved down to a lower side by the same amount.

Thereafter, by pulling the pivoting arm 17 further to the lower side by the hand, as shown by FIG. 6, the adjust bolt 15 is moved to a position at which the lower portion of the horizontal arm 16a is engaged with an engaging portion 29 of a side wall of the nail supply path of the magazine 4.

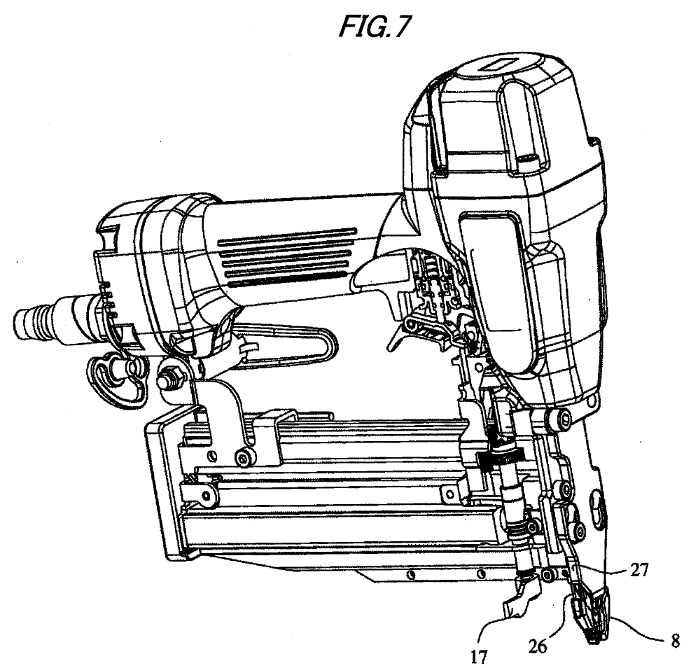

In this way, when the contact arm 12 is maximally moved to the lower side by pulling down the adjust bolt 15 by the hand, as shown by the drawing, the engaging groove 26 of the contact top 8 and the front end of the pivoting arm 17 are completely exposed from the lower end 27a of the cover portion 17 of the driver guide 5. Hence, as shown by FIG. 7, when the pivoting arm 17 is pivoted to be detached from the engaging groove 26, the contact top 28 becomes free. Hence, the freed contact top 8 may be pulled down to be detached from the wear plate 6.

In contrast thereto, when the contact top 8 is attached to the contact arm 12, in a state of maximally pulling down the contact arm 12 as described above, as shown by FIG. 2, the both side portions of the wear plate 6 are engaged with the inner side of the guide groove 25 of the contact top 8, pulled up by sliding to the upper side, further, the front end 17b is engaged with the engaging groove 26 of the contact top 8 by pivoting the pivoting arm 17 of the contact arm 12. Further, the contact arm 12 and the contact top 8 are supported by the hand and moved to the upper side by an amount in correspondence with the amount of pulling out the adjust bolt 15 and returns the adjust bolt 15 to the position of FIG. 5. By the movement to the upper side, the engaging groove 26 of the contact top 8 at the front end 17b of the pivoting arm 17 is held by being covered by the inner side of the cover portion 27 of the driver guide 5. Therefore, the pivoting arm 17 cannot be pivoted, and therefore, the contact top 8 is moved integrally in a state of being attached to the pivoting arm 17.

Further, the contact arm 12 and the contact top 8 are moved to the upper side by an amount of the adjust pulling down amount by pivoting the dial of the adjust bolt 15 in a reverse direction, the amount of adjusting the contact arm 12 relative to the adjust bolt 15 is returned to the initial position to be disposed at the position of FIG. 4, and the operation of pulling the trigger 10 is released. The operation of attaching the contact top 8 is finished thereby. Further, even when there is not the operation of pulling the trigger 10, when the contact arm 12 is maximally pulled down, the contact top 8 can be attached.

According to the method of attaching and detaching the contact top 8 having the above-described constitution, the following effect is achieved.

The contact arm 12 is pressed to a lower side of the tool main body 1 by the pulling operation of the trigger 10, a starting system of the nailing machine is completely shut off, and therefore, the operation of replacing the contact top 8 is carried out in a state of firmly ensuring safety. Further, the operation of replacing the contact top 8 is carried out by pressing the contact arm 12 to the lower side from the tool main body 1 by the operation of the pulling the trigger 10, and therefore, the replacing operation is easy to be carried out and an operational efficiency thereof is promoted.

According to the operation of attaching and detaching the contact top 8, the contact top 8 is detached from the pivoting arm 17 of the contact arm 12 disengaged from the driver guide 5 by being pressed down and pulled to the lower side of the tool main body 1, or attaching the contact top 8 to the pivoting arm 17. In this way, the operation of attaching and detaching the contact top 8 can be carried out without detaching the driver guide 5, and a necessity of a tool of a spanner or the like in the operation of replacing the contact top 8 is eliminated, and therefore, the operational performance can considerably be promoted.

Further, the amount of moving the contact arm 12 is constituted by adding the moving amount until exposing the engaging groove 26 of the contact top 8 from the driver guide 5 further to the moving amount in the normal use, and therefore, the engaging groove 26 of the contact top 8 is not exposed in the normal operation. Therefore, the contact top 8 is not detached from the pivoting arm at the front end of the contact arm 12 in an operation.

Further, as a mode of the front end portion of the contact arm 12 for attaching to the contact top 8, there maybe constructed a constitution of providing not the pivoting arm 17 pivoted centering on the adjust bolt 15 but the arm of the front end portion movably in the front and rear direction.

Although the invention has been explained in details and in reference to a specific embodiment, it is apparent for the skilled person that the invention can variously be changed or modified without deviating from the spirit and the range of the invention.

The application is based on Japanese Patent Application (Japanese Patent Application No. 2006-069679) filed on Mar. 14, 2006, and a content thereof is incorporated herein by reference.

### INDUSTRIAL APPLICABILITY

The invention can be applied to an attaching and detaching method of attaching or detaching the contact top to and from the front end of the contact arm of the nailing machine of a nail or the like.

1. A nailing machine comprising:
a wear plate provided on a lower side of a tool main body;
a driver guide arranged on the wear plate;
an injection port formed between the wear plate and the driver guide;
a contact top arranged at a lower end of the wear plate and slidable along a direction of striking a nail;
a contact arm provided at a vicinity of the injection port and movable in parallel with the direction of striking the nail; and
an engaging groove formed at a side portion of the contact top;
wherein the contact top is movable such that the engaging groove comes out and goes into an inner side of the driver guide;
wherein a front end portion of the contact arm is capable of being brought into contact with and separate from the contact top; and
wherein, in a state of maximally moving the front end portion of the contact arm to a lower side, the contact arm is capable of being attached to and detached from the engaging groove of the contact top exposed from an inner side of the driver guide.

2. The nailing machine according to claim 1, wherein an amount of moving the contact arm is constituted by adding a moving amount thereof until the contact top is completely exposed from the driver guide further to a moving amount in a normal use.
